(19) United States
(12) Patent Application Publication
(10) Pub. No.: US 2008/0106180 A1
(43) Pub. Date: May 8, 2008

(54) PLASMA DISPLAY PANEL AND PLASMA DISPLAY DEVICE INCLUDING THE PLASMA DISPLAY PANEL

(76) Inventor: Chong-Gi Hong, Yongin-si (KR)

Correspondence Address: CHRISTIE, PARKER & HALE, LLP, PO BOX 7068, PASADENA, CA, 91109-7068, US

(21) Appl. No.: 11/868,391

(22) Filed: Oct. 5, 2007

(30) Foreign Application Priority Data
Nov. 2, 2006 (KR) 10-2006-0107738

(51) Int. Cl. H01J 1/62

(52) U.S. Cl. 313/487; 313/486

(57) ABSTRACT

Provided is a plasma display panel that improves a black area ratio and a bright room contrast. The plasma display panel includes: front and rear substrates facing each other; barrier ribs disposed between the front and rear substrates to define discharge cells; address electrodes which extend in a first direction on the rear substrate and correspond to the discharge cells; a plurality of phosphor layers disposed in the discharge cells, wherein at least one of the phosphor layers is colored with a first chromatic color; display electrodes which extend in a second direction crossing the first direction on the front substrate and correspond to the discharge cells; and a front dielectric layer which is disposed on the front substrate to cover the display electrodes. The front dielectric layer is colored with a second chromatic color. The barrier ribs may be colored with a third chromatic color.

### CROSS-REFERENCE TO RELATED PATENT APPLICATION

This application claims priority to and the benefit of Korean Patent Application No. 10-2006-0107738, filed on Nov. 2, 2006, in the Korean Intellectual Property Office, the entire content of which is incorporated herein by reference.

### BACKGROUND OF THE INVENTION

(a) Field of the Invention

The present invention relates to a plasma display panel, and more particularly, to a plasma display panel having an improved black area ratio and bright room contrast.

(b) Description of the Related Art

In general, a plasma display panel uses a vacuum ultraviolet (VUV) ray which is irradiated from plasma obtained through a gas discharge. The VUV ray excites a phosphor material. The excited phosphor material is stabilized to generate visible light. According to a type of phosphor material, the visible light is viewed as red, green, or blue. These color components are properly combined to form an image.

For example, an AC-type plasma display panel has a structure in which address electrodes are formed on a rear substrate, and a dielectric layer covers the address electrodes. Further, a barrier rib is formed in a stripe shape on the dielectric layer. The barrier rib defines discharge cells. A phosphor layer is formed in the discharge cells. An inert gas is filled inside the discharge cells.

Display electrodes crossing the address electrodes are formed on a front substrate facing the rear substrate. The dielectric layer and a protective layer sequentially cover the display electrodes. If an external environment is bright, that is, under a bright room condition, external light is incident onto the panel and then overlaps light generated in the discharge cells. As a result, image display capability deteriorates.

Various attempts have been made in order to improve the image display capability of the plasma display panel. For example, a method in which a bright room contrast is improved by increasing a black area ratio and a method in which brightness is improved by increasing emission efficiency have been proposed.

### SUMMARY OF THE INVENTION

In exemplary embodiments according to the present invention, a plasma display panel that improves a black area ratio and a bright room contrast by coloring different layers in the panel without having to provide additional elements, is provided.

According to an aspect of an exemplary embodiment of the present invention, there is provided a plasma display panel including: front and rear substrates facing each other with a gap therebetween; barrier ribs disposed between the front and rear substrates to define discharge cells; address electrodes which extend in a first direction on the rear substrate and correspond to the discharge cells; a plurality of phosphor layers disposed in the discharge cells, wherein at least one of the phosphor layers is colored with a first chromatic color; display electrodes which extend in a second direction crossing the first direction on the front substrate and correspond to the discharge cells; and a front dielectric layer which is disposed on the front substrate to cover the display electrodes and is colored with a second chromatic color.

In the aforementioned aspect of an exemplary embodiment of the present invention, the first chromatic color and the second chromatic color may be complementary colors with respect to each other. Further, the second chromatic color may be selected from shades of yellow red, and the first chromatic color may be selected from shades of blue. Alternatively, the first chromatic color may be selected from shades of blue, and the second chromatic color may be selected from shades of yellow red.

In addition, at least one of manganese (Mn), nickel (Ni), or cobalt (Co) may be added to said at least one of the phosphor layers, so that said at least one of the phosphor layers has the first chromatic color. Further, at least one of copper (Cu), antimony (Sb), or chrome (Cr) may be added to the front dielectric layer, so that the front dielectric layer has the second chromatic color.

In addition, the plurality of phosphor layers may include a red phosphor layer for emitting red visible light, a green phosphor layer for emitting green visible light, and a blue phosphor layer for emitting blue visible light, and any one of the red, green, and blue phosphor layers may be colored with any one of red, green, and blue colors.

According to another aspect of an exemplary embodiment of the present invention, there is provided a plasma display panel including: front and rear substrates facing each other with a gap therebetween; barrier ribs disposed between the front and rear substrates to define discharge cells and colored with a third chromatic color; address electrodes which extend in a first direction on the rear substrate and correspond to the discharge cells; a plurality of phosphor layers disposed in the discharge cells, wherein at least one of the phosphor layers is colored with a first chromatic color; display electrodes which extend in a second direction crossing the first direction on the front substrate and correspond to the discharge cells; and a front dielectric layer which is disposed on the front substrate to cover the display electrodes and is colored with a second chromatic color.

In the aforementioned aspect of an exemplary embodiment of the present invention, the first chromatic color and the second chromatic color may be complementary colors with respect to each other. Further, the second chromatic color and the third chromatic color may be complementary colors with respect to each other. In one exemplary embodiment, the first chromatic color and the third chromatic color may be substantially the same.

According to another aspect of an exemplary embodiment of the present invention, there is provided a plasma display panel including: a rear substrate; a front substrate facing the rear substrate with a gap therebetween; barrier ribs disposed between the front and rear substrates to define discharge cells; address electrodes which extend in a first direction on the rear substrate and correspond to the discharge cells; a rear dielectric layer which covers the address electrodes and is colored with a second chromatic color; a plurality of phosphor layers disposed in the discharge cells, wherein at least one of the phosphor layers is colored with a first chromatic color; display electrodes which extend in a second direction crossing the first direction on the front substrate and correspond to the discharge cells; and a front dielectric layer which is disposed on the front substrate to cover the display electrodes.

In the aforementioned aspect of an exemplary embodiment of the present invention, the first and second chromatic colors may be complementary colors with respect to each other.

According to another aspect of an exemplary embodiment of the present invention, there is provided a plasma display panel including: a rear substrate; a front substrate facing the rear substrate with a gap therebetween; barrier ribs disposed between the front and rear substrates to define discharge cells and colored with a third chromatic color; address electrodes which extend in a first direction on the rear substrate and correspond to the discharge cells; a rear dielectric layer which covers the address electrodes and is colored with a second chromatic color; a plurality of phosphor layers disposed in the discharge cells, wherein at least one of the phosphor layers is colored with a first chromatic color; display electrodes which extend in a second direction crossing the first direction on the front substrate and correspond to the discharge cells; and a front dielectric layer which is disposed on the front substrate to cover the display electrodes.

In the aforementioned aspect of an exemplary embodiment of the present invention, the first and second chromatic colors may be complementary colors with respect to each other.

In addition, the second and third chromatic colors may be complementary colors with respect to each other.

According to a plasma display panel of an exemplary embodiment of the present invention, a phosphor layer is colored with a first chromatic color, and a front dielectric layer is colored with a second chromatic color, thereby improving a black area ratio and a bright room contrast of the panel.

According to another exemplary embodiment, the front dielectric layer is colored with the second chromatic color, the phosphor layer is colored with the first chromatic color, and barrier ribs are colored with a third chromatic color. Thus, the black area ratio and the bright room contrast of the panel are further improved.

According to another exemplary embodiment, the phosphor layer is colored with the first chromatic color, and the rear dielectric layer is colored with a fourth chromatic color, thereby improving the black area ratio and the bright room contrast of the panel.

According to another exemplary embodiment, the phosphor layer is colored with the first chromatic color, the rear dielectric layer is colored with the fourth chromatic color, and the barrier rib is colored with the third chromatic color. Thus, the black area ratio and the bright room contrast of the panel are further improved.

According to another exemplary embodiment, a plasma display device includes any of the plasma display panels of the exemplary embodiments according to the present invention.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial exploded perspective view of a plasma display panel according to a first embodiment of the present invention;

FIG. 2 is a cross-sectional view of the plasma display panel taken along the line II-II of FIG. 1;

FIG. 3 is a partial plan view of an image display area of a plasma display panel according to the first embodiment of the present invention;

FIG. 4 is a Munsell color system illustrating the complementary color relationship;

FIG. 5 is a partial exploded perspective view of a plasma display panel according to a second embodiment of the present invention;

FIG. 6 is a partial plan view of an image display area of a plasma display panel according to the second embodiment of the present invention;

FIG. 7 is a partial exploded perspective view of a plasma display panel according to a third embodiment of the present invention;

FIG. 8 is a partial plan view of an image display area of a plasma display panel according to the third embodiment of the present invention;

FIG. 9 is a partial exploded perspective view of a plasma display panel according to a fourth embodiment of the present invention;

FIG. 10 is a partial plan view of an image display area of the plasma display panel according to the fourth embodiment of the present invention; and

FIG. 11 is a block diagram of a plasma display device incorporating any of the plasma display panels of exemplary embodiments according to the present invention.

### DETAILED DESCRIPTION

Hereinafter, exemplary embodiments of the present invention will be described in detail with reference to the attached drawings such that the present invention can be easily put into practice by those skilled in the art. However, the present invention is not limited to the exemplary embodiments, but may be embodied in various forms.

There may be parts shown in the drawings, or parts not shown in the drawings, that are not discussed in the specification as they are not essential to a complete understanding of the invention. Like reference numerals designate like elements.

Hereinafter, exemplary embodiments of the present invention will be described in detail with reference to the accompanying drawings.

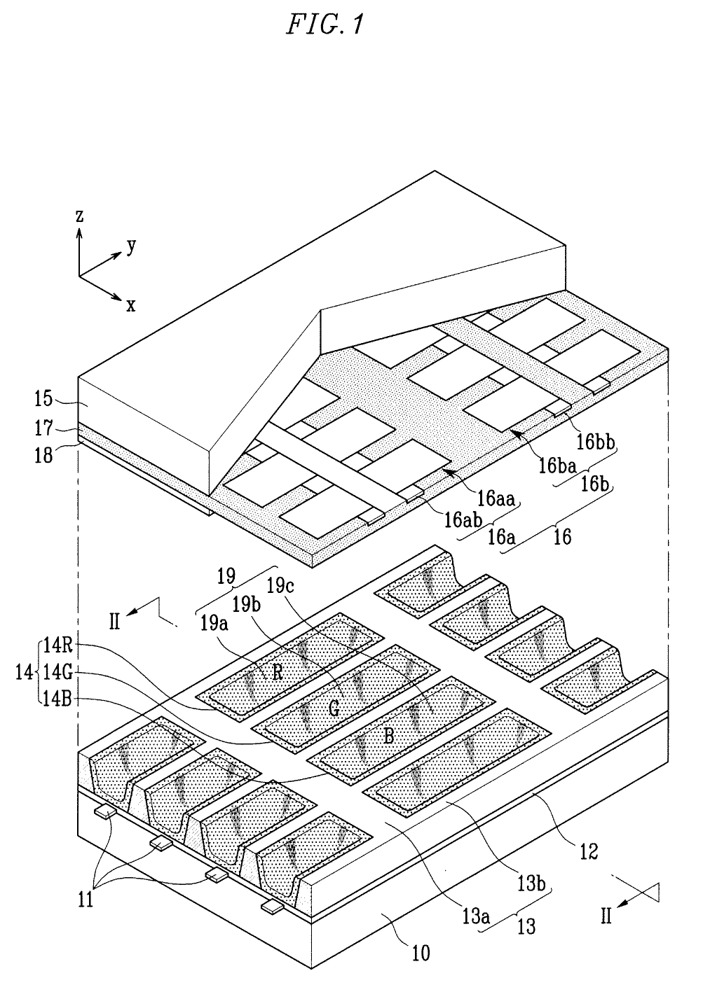

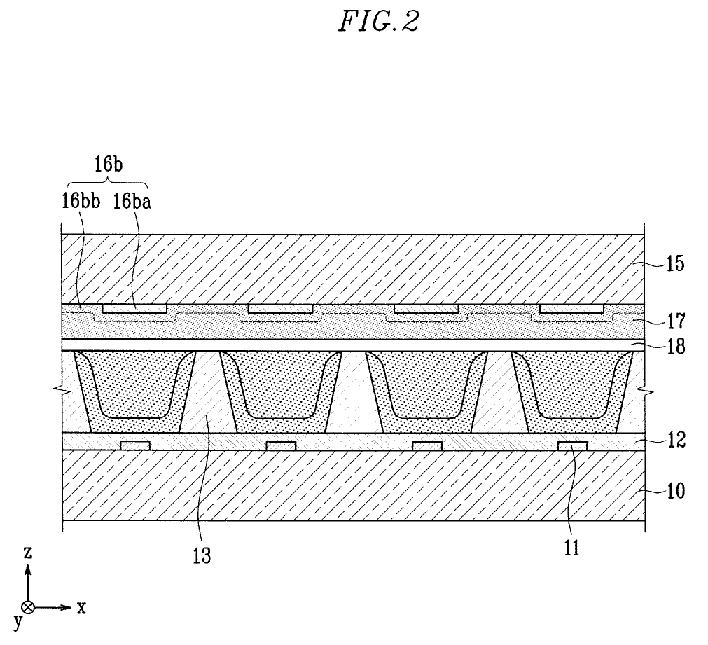

FIG. 1 is a partial exploded perspective view of a plasma display panel according to a first embodiment of the present invention. FIG. 2 is a cross-sectional view of the plasma display panel taken along the line II-II of FIG. 1.

Referring to FIGS. 1 and 2, the plasma display panel according to the first embodiment of the present invention includes a rear substrate 10, a front substrate 15, barrier ribs 13 that are formed between the two substrates 10 and 15 to define discharge cells 19, address electrodes 11 formed corresponding to the discharge cells 19, and display electrodes 16.

The rear substrate 10 and the front substrate 15 face each other in parallel with a specific distance therebetween. The address electrodes 11 extend in a first direction (i.e., y-axis direction in FIGS. 1 and 2) on the upper surface (as illustrated in FIGS. 1 and 2) of the rear substrate 10. The address electrodes 11 are adjacent with one another in parallel with a specific distance therebetween.

A rear dielectric layer 12 is formed on the upper surface (as illustrated in FIG. 2) of the rear substrate 10. The rear dielectric layer 12 covers the address electrodes 11. The address electrodes 11 are made of a metal material having a good conductivity such as silver (Ag). Moreover, the address electrodes 11 do not react with the rear dielectric layer 12 and the rear substrate 10 since the address electrodes 11 are chemically stable.

The display electrodes 16 extend in a second direction (i.e., x-axis direction in FIGS. 1 and 2) on the lower surface (as illustrated in FIG. 2) of the front substrate 15. The display electrodes 16 are adjacent with one another in parallel with a specific distance therebetween.

Each display electrode 16 includes a sustain electrode 16a and a scan electrode 16b which face each other in each discharge cell 19. The sustain electrode 16a and the scan electrode 16b respectively include transparent electrodes 16aa and 16ba and bus electrodes 16ab and 16bb. As shown in FIGS. 1 and 2, the bus electrodes 16ab and 16bb are formed at the lower surfaces of the transparent electrodes 16aa and 16ba. Moreover, the transparent electrodes 16aa and 16ba are spaced apart from each other to form a discharge gap.

The transparent electrodes 16aa and 16ba are made of a transparent material such as indium tin oxide (ITO), thereby easily transmitting visible light. However, the transparent electrodes 16aa and 16ba have a poor conductivity. Therefore, the bus electrodes 16ab and 16bb use a metal material having a good conductivity such as silver (Ag), so that voltage can be easily supplied to the transparent electrodes 16aa and 16ba.

As shown in FIGS. 1 and 2, a front dielectric layer 17 is formed at the lower surface (as illustrated in FIG. 2) of the front substrate 15. The front dielectric layer 17 covers the display electrodes 16. Thus, the front dielectric layer 17 protects the display electrodes 16 against a discharge phenomenon. Further, the front dielectric layer 17 allows a discharge to be easily produced in the discharge cells 19 by accumulating wall charges.

The front dielectric layer 17 is covered with a protective layer 18. The protective layer 18 is made of a transparent material. Thus, the protective layer 18 not only easily transmits visible light emitted from a phosphor layer 14 but also protects the front dielectric layer 17 against the discharge phenomenon. Further, the protective layer 18 serves to decrease a discharge ignition voltage by increasing a secondary electron emission coefficient. For example, the protective layer 18 may be made of magnesium oxide (MgO). Due to transparency of magnesium oxide (MgO), visible light produced in the discharge cells 19 can be easily transmitted.

As shown in FIGS. 1 and 2, the barrier ribs 13 are formed between the protective layer 18 and the rear dielectric layer 12 so as to define the discharge cells 19. Each barrier rib 13 includes a horizontal barrier member 13a and a vertical barrier member 13b.

The horizontal barrier member 13a extends in the second direction (i.e., x-axis direction in FIG. 1). The vertical barrier member 13b extends in the first direction (i.e., y-axis direction in FIG. 1). The horizontal barrier member 13a crosses the vertical barrier member 13b. In this embodiment of the present invention, the horizontal and vertical barrier members 13a and 13b define the discharge cells 19 in a matrix shape.

Besides the matrix shape, the discharge cells 19 according to this embodiment of the present invention may be formed in various forms such as a stripe shape or a delta shape. The matrix shaped barrier ribs 13 according to this embodiment of the present invention prevent cross-talk between the discharge cells 19 and provides a surface on which the phosphor layer 14 is applied.

As shown in FIG. 1, according to emission characteristics, the phosphor layer 14 includes a red phosphor layer 14R for generating red visible light, a green phosphor layer 14G for generating green visible light, and a blue phosphor layer 14B for generating blue visible light.

One unit of pixel is constructed with a discharge cell 19a in which the red phosphor layer 14R is formed, a discharge cell 19b in which the green phosphor layer 14G is formed, and a discharge cell 19c in which the blue phosphor layer 14B is formed. In this case, in order to improve emission brightness of the phosphor layer 14, white powder may be included.

A discharge gas that is an inert gas (e.g., a gas mixture of Ne and Xe) is filled in the discharge cells 19. The discharge gas generates a gas discharge between the sustain electrode 16a and the scan electrode 16b. Plasma is generated by the gas discharge. A vacuum ultraviolet (VUV) ray generated from the plasma allows the phosphor layer 14 to be excited. When the excited phosphor layer 14 is stabilized, visible light is generated. Color components of the visible light are combined to form an image.

In this embodiment of the present invention, the front dielectric layer 17 is colored with a second color (e.g., second chromatic color). Further, the phosphor layer 14 is colored with a first color (e.g., first chromatic color). The first and second colors are selected for their subtractive mixture properties. In particular, in this embodiment of the present invention, the second color of the front dielectric layer 17 and the first color of the phosphor layer 14 are complementary colors with respect to each other.

As described above, the phosphor layer 14 includes the red phosphor layer 14R, the green phosphor layer 14G, and the blue phosphor layer 14B. In one embodiment, all three of the red, green and blue phosphor layers 14R, 14G and 14B are colored. In other embodiments, only one or two of the phosphor layers may be colored. The red, green and blue phosphors may be colored with the same or different colors. By way of example, two of the three color phosphors may be colored with a first color while the third phosphor is colored with another color different from the first color. Of course, the phosphor layers may be colored with different respective colors. For example, the red phosphor layer 14R may be colored with red, the green phosphor layer 14G may be colored with green, and the blue phosphor layer 14B may be colored with blue.

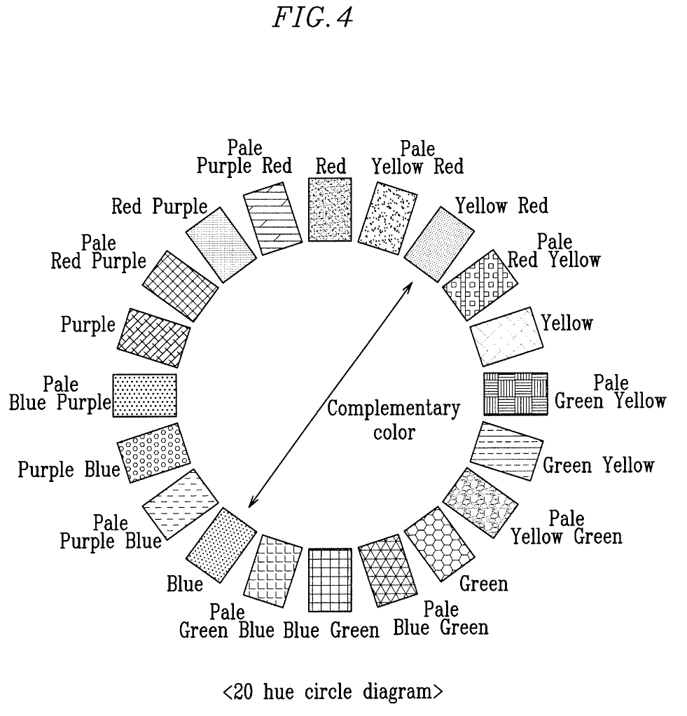

The type of the second color of the front dielectric layer 17 and the type of the first color of the phosphor layer 14 will be described later in detail with reference to FIG. 4.

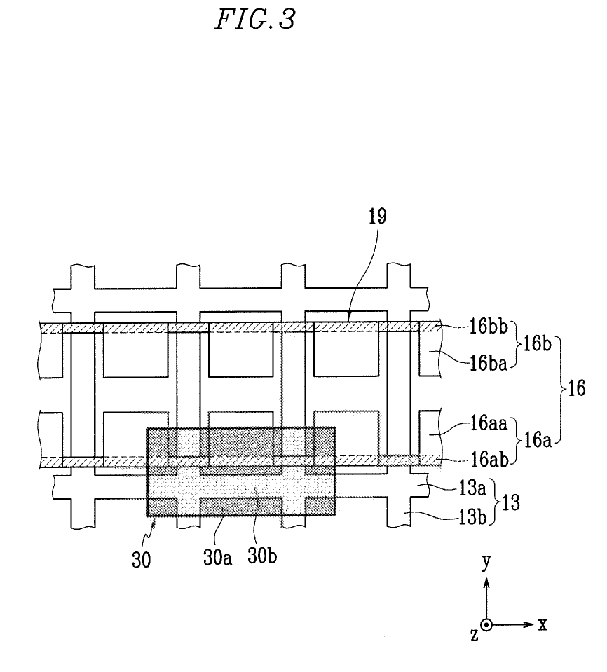

FIG. 3 is a partial plan view of an image display area of a plasma display panel according to the first embodiment of the present invention.

The first embodiment of the present invention will now be described with reference to FIG. 3. The same elements will be referenced by the same reference numbers. The same description will not be repeated.

As show in FIGS. 1 to 3, the sustain electrode 16a and the scan electrode 16b are formed in pair in the second direction (i.e., x-axis direction in FIGS. 1-3) along the discharge cells 19. The bus electrodes 16ab and 16bb are formed at the lower surface of the transparent electrodes 16aa and 16ba.

As shown in FIG. 3, the plasma display panel has an image display area 30 in which an image is displayed. Only a part of the image display area 30 is shown in FIG. 3. The image display area 30 includes a first area 30a, in which the phosphor layer 14 is visible through the front substrate 15 and the front dielectric layer 17, and a second area 30b in which the barrier ribs 13 are invisible through the front substrate 15 and the front dielectric layer 17.

According to this embodiment of the present invention, if the front dielectric layer 17 is colored with blue, and the phosphor layer 14 is colored with yellow red, then an area where the front dielectric layer 17 and the phosphor layer 14 are superimposed has a black color, substantially black color, or a color close to black. In addition, if the front dielectric layer 17 is colored with yellow red, and the phosphor layer 14 is colored with blue, an area where the front dielectric layer 17 and phosphor layer 14 are superimposed has a black color, substantially black color, or a color close to black. A black area ratio of the panel increases according to a black color characteristic. Further, by absorbing light externally irradiated, a reflective brightness of the panel can be reduced.

In this embodiment of the present invention, in order to color the front dielectric layer 17 and the phosphor layer 14 with the first color and the second color, respectively, a coloring material is added to the layers 17 and 14. The coloring material may be coated on a surface of the layers or may be mixed with an ingredient of the layers.

To obtain a blue color, at least one material selected from a group consisting of manganese (Mn), nickel (Ni), and cobalt (Co) or any other suitable material or materials may be added to a layer to be colored or may be coated on a surface of the layer. To obtain a yellow red color, at least one material selected from a group consisting of copper (Cu), antimony (Sb), and chrome (Cr) or any other suitable material or materials may be colored on a layer to be colored or may be coated on a surface of the layer.

Any one of the red, green, and blue phosphor layers 14R, 14G, and 14B may be colored with any one of colors of red, green, and blue. For example, when the red phosphor layer 14R is colored with red, color purity may increase. When the green phosphor layer 14G is colored with green, color purity may increase. When the blue phosphor layer 14B is colored with blue, color purity may increase.

In this embodiment of the present invention, a coloring material may be added to the phosphor layer 14. In order to avoid degradation of emission characteristics of the phosphor layer 14, the coloring material may have a particle size less than that of a phosphor material. The coloring material may be coated on the surface of the phosphor particles or may be mixed with the phosphor particles. In addition, the coloring material may be separately coated on the surface of the phosphor layer 14.

FIG. 4 is a Munsell color system illustrating the complementary color relationship.

If an achromatic color is produced when two colors are superimposed or mixed, the two colors have a complementary color relationship. The achromatic color refers to a color that lacks hue, such as black, white and shades of gray. In a subtractive system, black is produced when complementary colors are superimposed or mixed. A chromatic color is a color having a hue, such as any color other than black, white and shades of gray. Referring to FIG. 4, blue is a complementary color of yellow red. Red is a complementary color of blue green. Purple is a complementary color of green yellow.

Although not shown in the Munsell color system, black is a complementary color of white. Likewise, there are countless colors in a complementary color relation.

A dark color close to black can be obtained through a subtractive mixture of two colors substantially in a complementary color relationship, even if the two colors are not exactly in the complementary color relationship. The dark color easily absorbs light. For example, in FIG. 4, pale yellow red is not a complementary color of blue, but pale yellow red is close to yellow red that is a complementary color of blue. In this case, if blue and pale yellow red are subtractive-mixed, a resultant color is close to black.

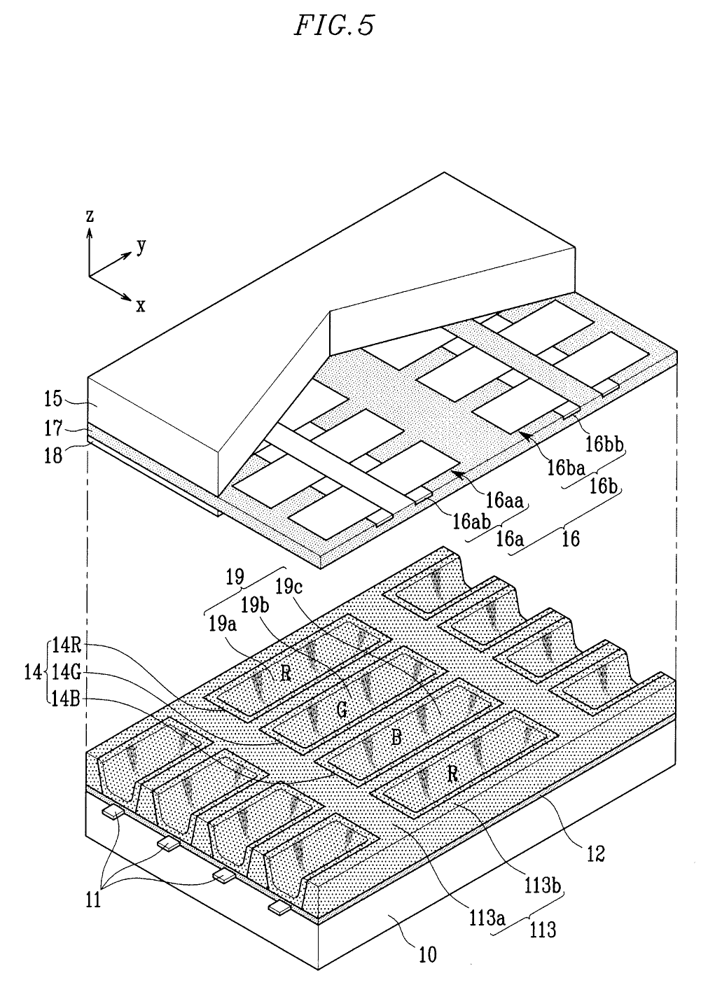

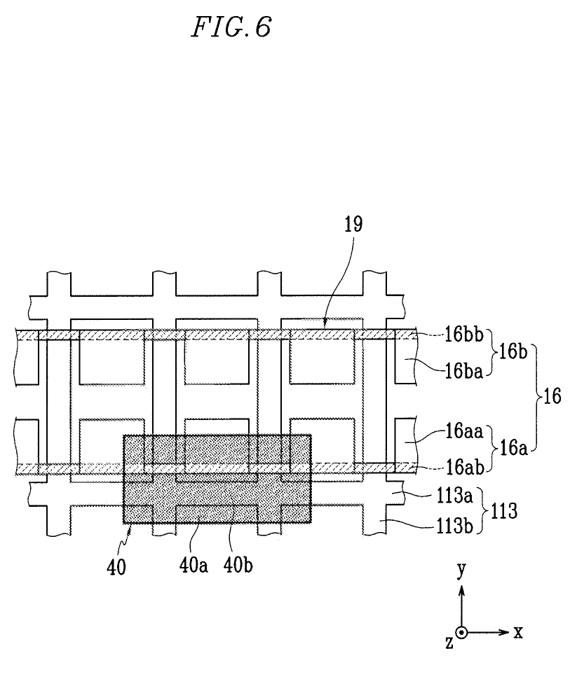

FIG. 5 is a partial exploded perspective view of a plasma display panel according to a second embodiment of the present invention. FIG. 6 is a partial plan view of an image display area of a plasma display panel according to the second embodiment of the present invention.

The second embodiment of the present invention will now be described with reference to FIGS. 5 and 6. The same elements will be referenced by the same reference numbers. The same description will not be repeated.

Referring to FIG. 5, a front dielectric layer 17 is colored with a second color. A phosphor layer 14 is colored with a first color. Barrier ribs 113 (113a and 113b) are colored with a third color (e.g., third chromatic color). The barrier ribs 113 (113a and 113b) are substantially the same as the barrier ribs 13 (13a and 13b) of FIG. 1, except that the barrier ribs 113 are colored with the third color. In one exemplary embodiment, the third color is substantially the same as the first color. In other embodiments, the first and third colors may be same or different.

Referring to FIG. 6, the plasma display panel has an image display area 40 on which an image is displayed. Only a part of the image display area 40 is shown in FIG. 6.

The image display area 40 includes a first area 40a, in which the phosphor layer 14 is visible through the front dielectric layer 17, and a second area 40b in which the barrier ribs 113 are visible through the front dielectric layer 17.

As shown in FIG. 6, if the second color of the front dielectric layer 17 is yellow red, and the first color of the phosphor layer 14 is blue, then an area where the second color and the first color are superimposed has a black color, substantially black color, or a color close to black. In addition, if the second color of the front dielectric layer 17 is yellow red, and the third color of the barrier ribs 113 is blue, then an area where the second color and the third color are superimposed has a black color, substantially black color, or a color close to black.

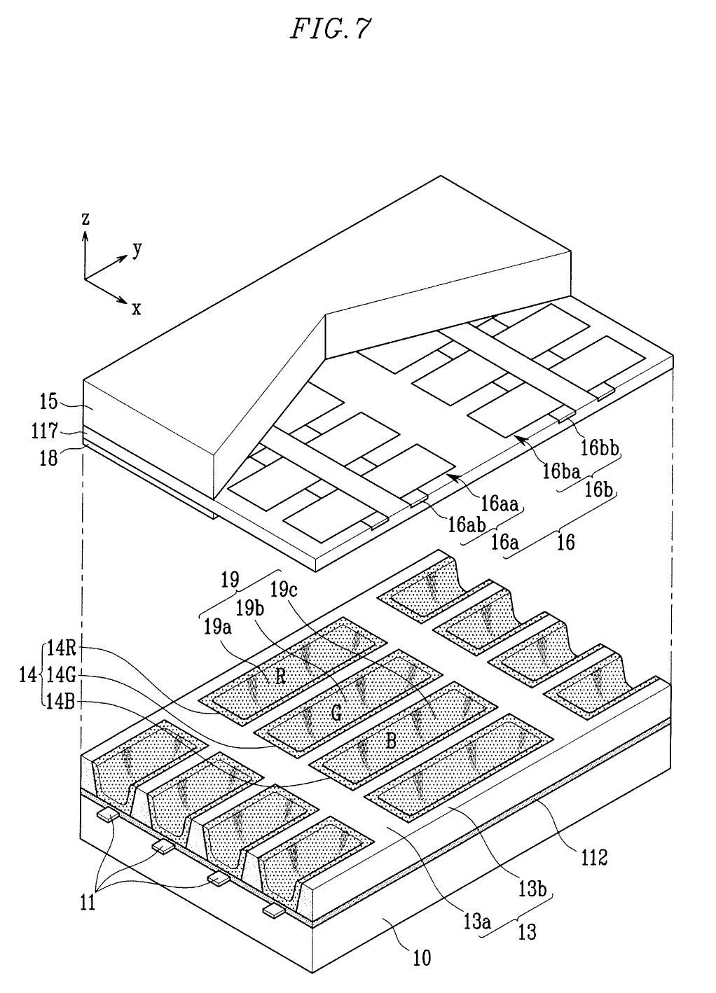

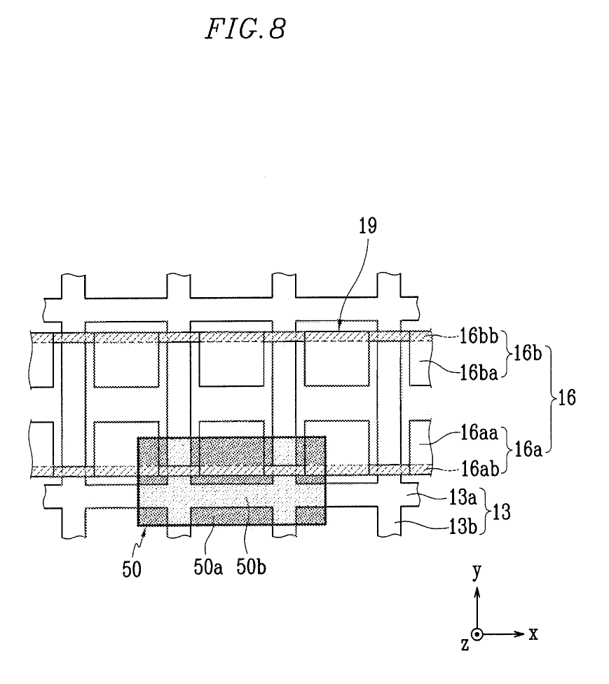

FIG. 7 is a partial exploded perspective view of a plasma display panel according to a third embodiment of the present invention. FIG. 8 is a partial plan view of an image display area of a plasma display panel according to the third embodiment of the present invention.

The third embodiment of the present invention will now be described with reference to FIGS. 7 and 8. The same elements will be referenced by the same reference numbers. The same description will not be repeated.

According to this embodiment of the present invention, a rear dielectric layer 112 is colored with a fourth color (e.g., fourth chromatic color). The rear dielectric layer 112 is substantially the same as the rear dielectric layer 12 of FIG. 1, except that the rear dielectric layer 112 is colored with the fourth color. A phosphor layer 14 is colored with a first color. The first and fourth colors are selected for their subtractive mixture properties. In particular, in this embodiment of the present invention, the fourth color of the rear dielectric layer 112 and the first color of the phosphor layer 14 are complementary colors with respect to each other.

Referring to FIG. 8, the plasma display panel has an image display area 50 on which an image is displayed. Only a part of the image display area 50 is shown in FIG. 8.

The image display area 50 includes a first area 50a, in which the phosphor layer 14 is visible through the front substrate 15 and a front dielectric layer 117, and a second area 50b in which the barrier ribs 13 are not seen through the front substrate 15 and the front dielectric layer 117. The front dielectric layer 117 is substantially the same as the front dielectric layer 17 of FIG. 1, except that the front dielectric layer 117 is not colored with a second color.

In this embodiment of the present invention, if the rear substrate 112 is colored with yellow red, and the phosphor layer 14 is colored with blue, then an area where the two layers 112 and 14 are superimposed has a black color, substantially black color, or a color close to black. On the contrary, if the rear dielectric layer 112 is colored with blue, and the phosphor layer 14 is colored with yellow red, then an area where the two layers 112 and 14 are superimposed has a black color, substantially black color, or a color close to black. Accordingly, a black area ratio and a bright room contrast of the plasma display panel can be improved. Further, a reflective brightness can be reduced.

In this embodiment of the present invention, the first area 50a is an area in which the first color of the phosphor layer 14 is superimposed with the fourth color of the rear dielectric layer 112. Since the first and fourth colors are complementary colors with respect to each other, the first area 50a is black, substantially black, or has a color close to black.

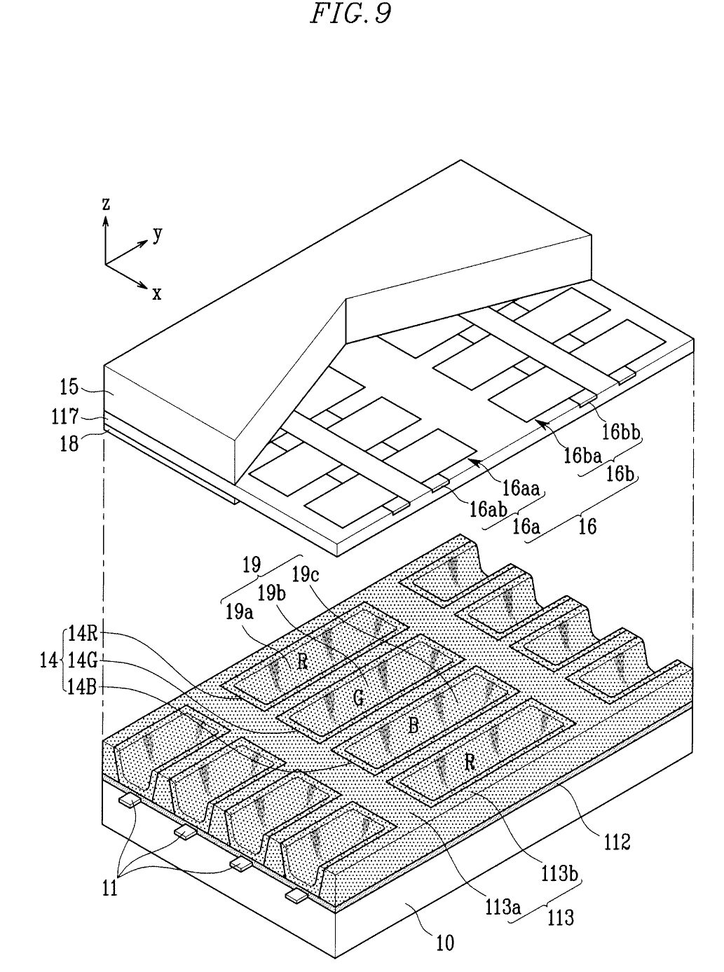

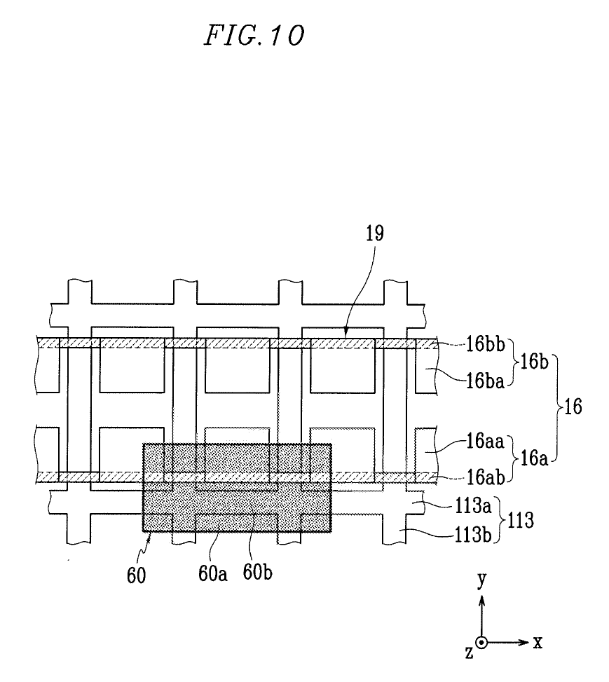

FIG. 9 is a partial perspective view of a plasma display panel according to a fourth embodiment of the present invention. FIG. 10 is a partial plan view of an image display area of the plasma display panel according to the fourth embodiment of the present invention.

The fourth embodiment of the present invention will now be described with reference to FIGS. 9 and 10. The same elements will be referenced by the same reference numbers. The same description will not be repeated.

In comparison with FIG. 7, a barrier rib 113 of FIG. 9 is additionally colored with the third color. In general, glass powder having a low melting point, organic solvent (e.g., resin), or filer (aluminum or metal powder) is included in the barrier rib 113. In this embodiment of the present invention, a coloring material is added to the barrier rib 113 in order to enhance a black area ratio.

If the barrier rib 113 is white, the plasma display panel has a low black area ratio. The decrease in the black area ratio leads to the decrease in contrast and increase in reflective brightness. In this embodiment of the present invention, the third color of the barrier rib 113 and the fourth color of the rear dielectric layer 112 are selected for their subtractive mixture properties. In particular, the third color of the barrier rib 113 and the fourth color of the rear dielectric layer 112 are complementary colors with respect to each other.

Referring to FIG. 10, the plasma display panel has an image display area 60 on which an image is displayed. Only a part of the image display area 60 is shown in FIG. 10.

The image display area 60 includes a first area 60a, in which the phosphor layer 14 is visible through the front substrate 15 and the front dielectric layer 117, and a second area 60b in which the barrier ribs 113 are not seen through the front substrate 15 and the front dielectric layer 117.

As shown in FIG. 10, if the phosphor layer 14 is colored with blue, and the rear dielectric layer 112 is colored with yellow red, then an area where the phosphor layer 14 and the rear dielectric layer 112 are superimposed has a black color, substantially black color, or a color close to black.

On the other hand, if the phosphor layer 14 is colored with yellow red, and the rear dielectric layer 112 is colored with blue, then an area where the phosphor layer 14 and the rear dielectric layer 112 are superimposed has a black color, substantially black color, or a color close to black.

If the rear dielectric layer 112 is colored with yellow red, and the barrier rib 113 is colored with blue, then an area where the rear dielectric layer 112 and the barrier rib 113 are superimposed also has a black color, substantially black color, or a color close to black. Furthermore, if the rear dielectric layer 112 is colored with blue, and the barrier rib 113 is colored with yellow red, then an area where the rear dielectric layer 112 and the barrier rib 113 are superimposed has a black color, substantially black color, or a color close to black.

Therefore, the plasma display panel has an improved black area ratio and an improved bright room contrast. In particular, in this embodiment of the present invention, the first and second areas 60a and 60b both have a black color or a dark color close to black.

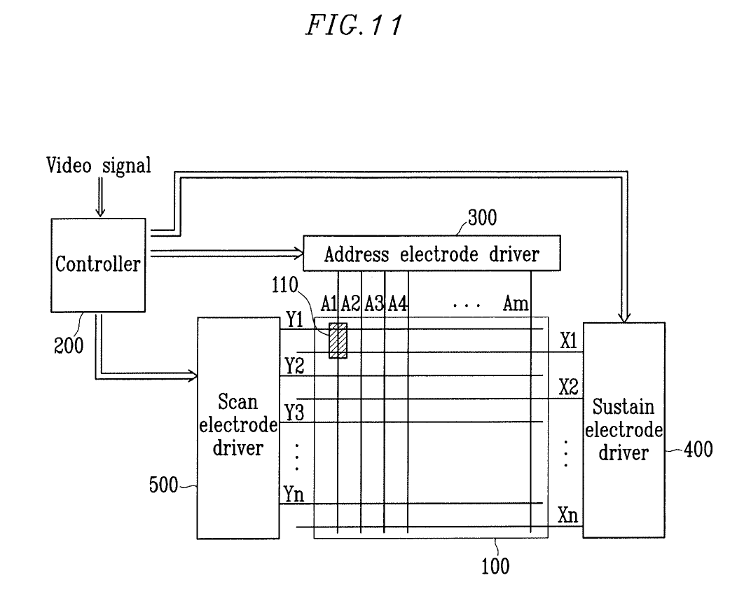

Referring now to FIG. 11, a plasma display device according to an exemplary embodiment of the present invention includes a plasma display panel (PDP) 100, a controller 200, an address electrode driver 300, a sustain electrode driver 400, and a scan electrode driver 500. The sustain electrode driver 400 and/or the scan electrode driver 500 may also be referred to as a display electrode driver, either individually or together. The PDP 100 may be any one of the PDPs disclosed in FIGS. 1-3 and 5-10 according to embodiments of the present invention.

The PDP 100 includes a plurality of address electrodes A1 to Am (hereinafter, referred to as “A electrodes”) extending in a column direction, and a plurality of sustain and scan electrodes X1 to Xn and Y1 to Yn (hereinafter, referred to as “X electrodes” and “Y electrodes”) extending in a row direction in pairs. The X electrodes and the Y electrodes may also be referred to as display electrodes. In general, the X electrodes X1 to Xn respectively correspond to the Y electrodes Y1 to Yn, and the Y and X electrodes Y1 to Yn and X1 to Xn are arranged to cross the A electrodes A1 to Am. In this case, a discharge space at a crossing region of the A electrodes A1 to Am and the X and Y electrodes X1 to Xn and Y1 to Yn forms a discharge cell 110. One or more of the phosphors formed in the discharge cells are colored with a first color (e.g., first chromatic color) in exemplary embodiments according to the present invention.

The controller 200 receives an external video signal, outputs driving control signals, divides a frame into a plurality of subfields having respective brightness weight values, and drives them. Each subfield has at least an address period and a sustain period. The A, X, and Y electrode drivers 300, 400, 500 respectively apply driving voltages to the A electrodes A1 to Am, the X electrodes X1 to Xn, and the Y electrodes Y1 to Yn in response to the driving control signals from the controller 200. The driving voltages provided to the A electrodes may also be referred to as address signals. the driving voltages provided to the X electrodes and the Y electrodes may also be referred to as display signals, which may include sustain signals and/or scan signals.

While the present invention has been particularly shown and described with reference to exemplary embodiments thereof, it will be understood by those skilled in the art that various changes in form and details may be made therein without departing from the spirit and scope of the present invention as defined by the appended claims and their equivalents.

What is claimed is:

1. A plasma display panel comprising:
a rear substrate;
a front substrate facing the rear substrate with a gap therebetween;
barrier ribs disposed between the front and rear substrates to define discharge cells;
address electrodes extending in a first direction on the rear substrate and corresponding to the discharge cells;
a plurality of phosphor layers disposed in the discharge cells, wherein at least one of the phosphor layers is colored with a first chromatic color;
display electrodes extending in a second direction crossing the first direction on the front substrate and corresponding to the discharge cells; and
a front dielectric layer disposed on the front substrate to cover the display electrodes and colored with a second chromatic color.

2. The plasma display panel of claim 1, wherein the first chromatic color and the second chromatic color are complementary colors with respect to each other.

3. The plasma display panel of claim 2, wherein the second chromatic color is selected from shades of yellow red, and the first chromatic color is selected from shades of blue.

4. The plasma display panel of claim 2, wherein the first chromatic color is selected from shades of blue, and the second color is selected from shades of yellow red.

5. The plasma display panel of claim 4, wherein at least one of manganese (Mn), nickel (Ni), or cobalt (Co) is added to said at least one of the phosphor layers, such that said at least one of the phosphor layers has the first chromatic color.

6. The plasma display panel of claim 4, wherein at least one of copper (Cu), antimony (Sb), or chrome (Cr) is added to the front dielectric layer, such that the front dielectric layer has the second chromatic color.

7. The plasma display panel of claim 1, wherein the plurality of phosphor layers comprise a red phosphor layer for emitting red visible light, a green phosphor layer for emitting green visible light, and a blue phosphor layer for emitting blue visible light, and any one of the red, green, and blue phosphor layers is colored with any one of red, green, and blue colors.

8. The plasma display panel of claim 1, wherein the barrier ribs are colored with a third chromatic color.

9. The plasma display panel of claim 8, wherein the first chromatic color and the second chromatic color are complementary colors with respect to each other.

10. The plasma display panel of claim 8, wherein the second chromatic color and the third chromatic color are complementary colors with respect to each other.

11. The plasma display panel of claim 8, wherein the second chromatic color and the third chromatic color appear substantially black when superimposed with each other.

12. The plasma display panel of claim 8, wherein the first chromatic color and the third chromatic color are substantially the same.

13. The plasma display panel of claim 1, wherein the first chromatic color and the second chromatic color together appear substantially black when superimposed with each other.

14. The plasma display panel of claim 1, wherein at least two of the phosphor layers are colored with the first chromatic color.

15. A plasma display panel comprising:
a rear substrate;
a front substrate facing the rear substrate with a gap therebetween;
barrier ribs disposed between the front and rear substrates to define discharge cells;
address electrodes extending in a first direction on the rear substrate and corresponding to the discharge cells;
a rear dielectric layer covering the address electrodes and colored with a second chromatic color;
a plurality of phosphor layers disposed in the discharge cells, wherein at least one of the phosphor layers is colored with a first chromatic color;
display electrodes extending in a second direction crossing the first direction on the front substrate and corresponding to the discharge cells; and
a front dielectric layer disposed on the front substrate to cover the display electrodes.

16. The plasma display panel of claim 15, wherein the first chromatic color and the second chromatic color are complementary colors with respect to each other.

17. The plasma display panel of claim 15, wherein the barrier ribs are colored with a third chromatic color.

18. The plasma display panel of claim 17, wherein the second chromatic color and the third chromatic color together appear substantially black when superimposed with each other

19. The plasma display panel of claim 17, wherein the second chromatic color and the third chromatic color are complementary colors with respect to each other.

20. A plasma display panel comprising:
a rear substrate;
a front substrate facing the rear substrate with a gap therebetween;
barrier ribs disposed between the front and rear substrates to define discharge cells;
address electrodes extending in a first direction on the rear substrate and corresponding to the discharge cells;
a rear dielectric layer covering the address electrodes;
a plurality of phosphor layers disposed in the discharge cells, wherein at least one of the phosphor layers is colored with a first chromatic color;
display electrodes extending in a second direction crossing the first direction on the front substrate and corresponding to the discharge cells; and
a front dielectric layer disposed on the front substrate to cover the display electrodes,
wherein at least one of the front dielectric layer or the rear dielectric layer is colored with a second chromatic color.

21. The plasma display panel of claim 20, wherein the barrier ribs are colored with a third chromatic color.

22. A plasma display device comprising a plasma display panel, and further comprising:
an address electrode driver adapted to provide address signals to the plasma display panel;
at least one display electrode driver adapted to provide display signals to the plasma display panel; and
a controller adapted to convert a video signal to driving control signals and to provide the driving control signals to the address electrode driver and said at least one display electrode driver,
wherein the plasma display panel comprises:
a rear substrate;
a front substrate facing the rear substrate with a gap therebetween;
barrier ribs disposed between the front and rear substrates to define discharge cells;
address electrodes extending in a first direction on the rear substrate and corresponding to the discharge cells, the address electrodes being coupled to the address electrode driver to receive the address signals;
a rear dielectric layer covering the address electrodes;
a plurality of phosphor layers disposed in the discharge cells, wherein at least one of the phosphor layers is colored with a first chromatic color;
display electrodes extending in a second direction crossing the first direction on the front substrate and corresponding to the discharge cells, the display electrodes being coupled to the display electrode driver to receive the display signals; and
a front dielectric layer disposed on the front substrate to cover the display electrodes,
wherein at least one of the front dielectric layer or the rear dielectric layer is colored with a second chromatic color.

23. The plasma display device of claim 22, wherein the barrier ribs are colored with a third chromatic color.
